(19) United States
(12) Patent Application Publication
(10) Pub. No.: US 2010/0326371 A1
(43) Pub. Date: Dec. 30, 2010

(54) RETRACTABLE PET LEASH

(75) Inventors: Rip J. Lopusnak, Secaucus, NJ (US); Sascha Prochaska, Secaucus, NJ (US)

Correspondence Address: STROOCK & STROOCK & LAVAN LLP, 180 MAIDEN LANE, NEW YORK, NY, 10038, US

(73) Assignee: THE HARTZ MOUNTAIN CORPORATION, Secaucus, NJ (US)

(21) Appl. No.: 12/743,663

(22) PCT Filed: Mar. 2, 2009
(86) PCT No.: PCT/US09/35701

§ 371 Date: Sep. 14, 2010

Related U.S. Application Data
(60) Provisional application No. 61/032,780, filed on Feb. 29, 2008.

(51) Int. Cl. A01K 27/00

(52) U.S. Cl. 119/796; 119/797

(57) ABSTRACT

A retractable leash, having a spherical housing in which a line and a mechanism for retracting the line is provided The line includes a clasp for connecting to an animal, via its collar, The mechanism includes a rotatable gear rotating in a first direction to retract the line into the housing and a second direction when the line extends out of the housing The leash can include a button which a user depresses to stop or restrict the retraction and extension of the line, and preferably includes a locked position in which the restriction of the line can be maintained even if the user releases the button The leash includes a wrist strap and a hand strap attached to the housing, wherein the hand strap positions and secures the housing to the palm of a user's hand such that the button is proximate a finger of the user's hand

### CROSS-REFERENCE TO RELATED APPLICATIONS

This application claims the benefit of U.S. Provisional Application Ser. No. 61/032,780, filed on Feb. 29, 2008, entitled “BALL-SHAPED RETRACTABLE PET LEASH”, which is hereby incorporated in its entirety by reference.

### TECHNICAL FIELD OF THE INVENTION

The invention relates generally to a leash or lead for handling domestic animals, such as one suitable to use on house pets such as dogs. More particularly, the invention relates to a retractable leash having a housing and a line (rope, cord, etc.), wherein the line can extend from and retract into the housing.

### BACKGROUND OF THE INVENTION

Various leashes, including retractable leashes, are available in the market. However, retractable leashes typically include a handle which the user (the person holding the leash) must grasp and hold on to while walking the pet. If the user loses grip on the handle, for example, if the pet suddenly speeds up, the handle may fall out of the user's hands. Additionally, the user's hand may cramp or their grip may tire from holding the handle for an extended period of time, for example, while jogging with a dog. There is also typically undue torque on a user's hand and wrist based on the force vector from the typical retractable leash to the user's hand.

Accordingly, there is a need to provide a retractable leash that overcomes the drawbacks of leashes available.

### SUMMARY OF THE INVENTION

The invention relates to a retractable leash having a housing into which the line, which preferably connects to the collar of the pet, can be retracted and housed. The housing preferably includes a core about which the line can be wound when the line is being retracted, and unwound when the line is being extended. A stopping mechanism can be provided to stop the line from retracting/extending. It and preferably includes a locking mechanism to maintain the length of the line at a desired length by preventing the line from retracting or extending. The leash preferably includes a wrist strap for securing the housing to the user's hand, so as not to drop or lose hold of the leash. The strap can be a loop sized to pass over a user's hand. The wrist strap can include a slide clasp for that one can adjust the size of the loop. More preferably, the leash includes a second strap to secure the housing against the palm of the user without requiring the user to grasp the housing, a handle, or other mechanism. Rather, the housing, which is preferably spherical in shape, can fit and be maintained in the palm of the user's hand without requiring the user to exert any gripping force on the housing. A preferred overall diameter of the sphere is about 2 to 3 inches.

The housing can include a button or slide that the user may press or slide to stop the line from extending or retracting. While the button is depressed, the line is preferably prevented from extending or retracting. In accordance with an embodiment of the invention, the button can slide into a lock position, after which the user may release the button and the button will remain in the locked position. The locking mechanism within the housing can prevent the line from extending or retracting after the button is released. In one embodiment of the invention, it is friction clamped in place. However, it is preferred to be locked, such as by a cam extending into a detent or gear. The button is preferably positioned on the housing such that the user's finger(s) or thumb rest on or proximate the button when the housing is strapped to the user's hand, thus facilitating depressing (locking) the button when the user chooses.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiments set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 is a perspective view of a retractable leash system in accordance with an embodiment of the invention;

FIG. 2 is an exploded perspective view of the leash of FIG. 1;

FIG. 3 is a side view of the leash of FIG. 1;

FIG. 4 is a top view of the leash of FIG. 1;

FIG. 5 is a cross-sectional view of the leash of FIG. 4 taken along line 5-5;

FIG. 6 is a transparent perspective view of a leash in accordance with an embodiment of the invention; and

FIG. 7 is an exploded perspective view of a leash in accordance with an embodiment of the invention.

### DETAILED DESCRIPTION OF THE PREFERRED EMBODIMENTS

Detailed illustrative embodiments of the present invention are disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative.

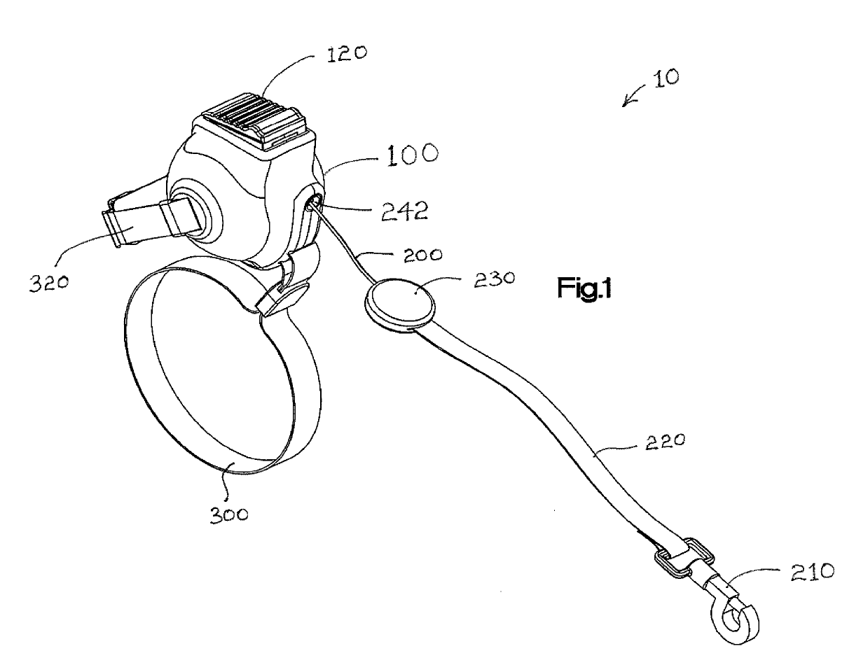

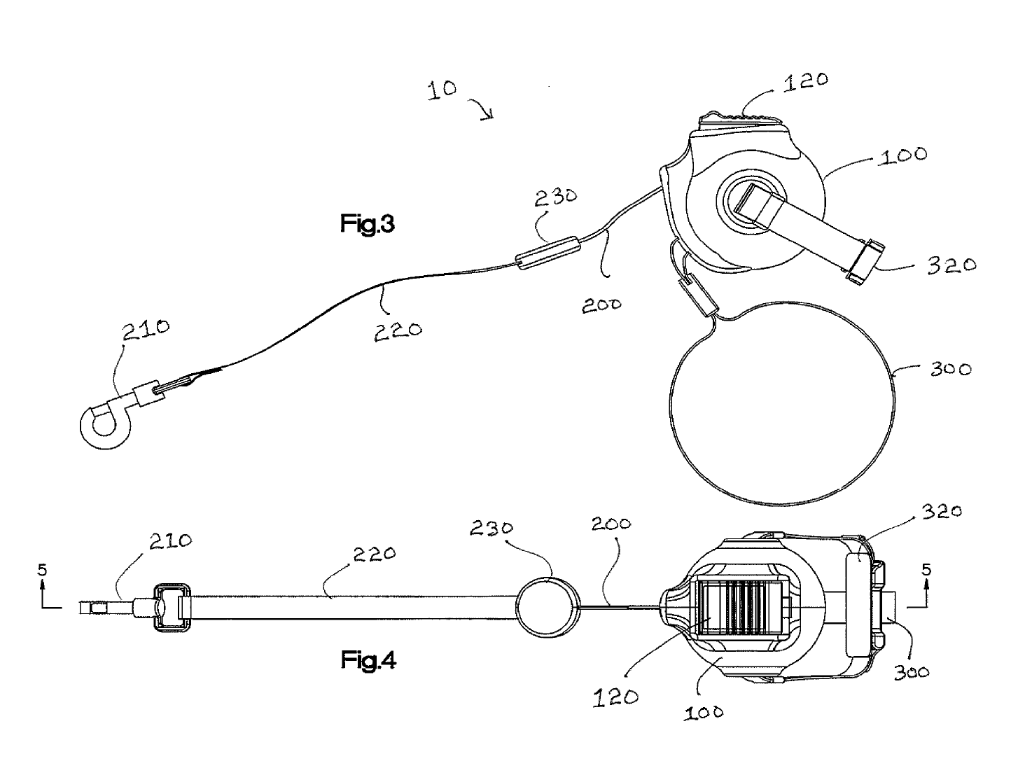

Reference is made to FIGS. 1-5, wherein an embodiment of a retractable leash system 10 is shown as having a housing 100 and a line 200, wherein line 200 extends from housing 100. Line 200 is preferably selectively extendable when pulled out of the housing 100 and retractable via a retracting mechanism located in housing 100. For example, line 200 can extend out from housing 100 when pulled or tugged on by the pet whose collar is attached to line 200. Line 200 can be made from a variety of natural and synthetic materials.

As shown, line 200 can be connected to the pet's collar, garment, etc., via a clasp 210, or other suitable connecting member. Preferably, a collar strap 220 is provided between clasp 210 and line 200 to connect clasp 210 to line 200. Preferably, collar strap 220 is made from a material that is sufficiently resilient to withstand the twists and pulls by the pet. In accordance with an embodiment, a collar connector 230 can be provided between line 200 and collar strap 220, wherein both line 200 and collar strap 220 are connected to collar connector 230.

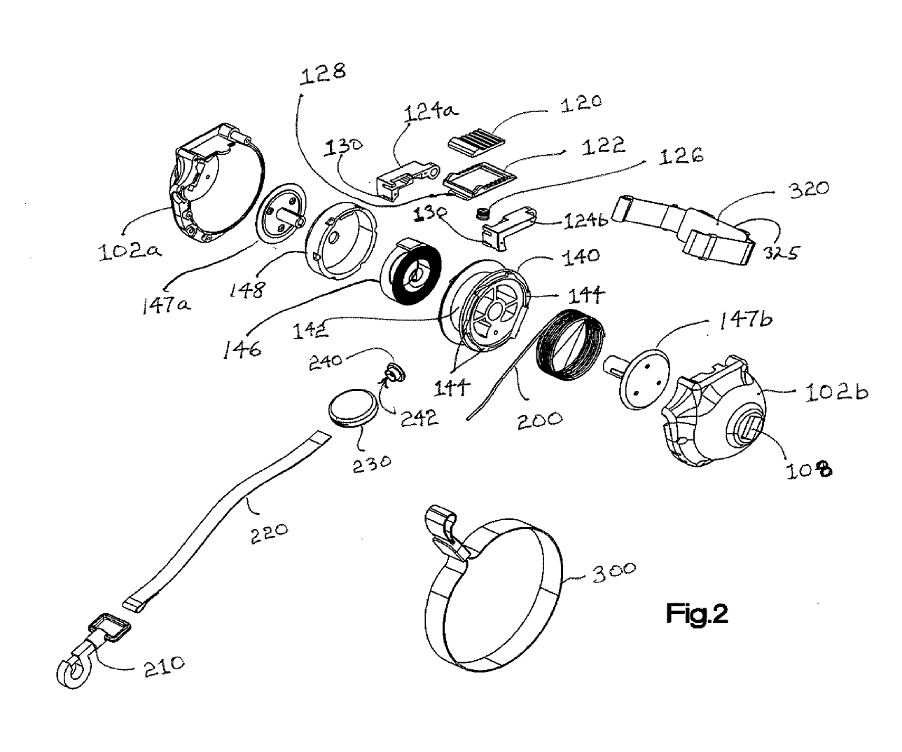

Referring to FIGS. 2 and 5, housing 100 can include a first shell 102a and a second shell 102b that can interconnect to form outer shell of housing 100. Housing 100 preferably encloses a line retraction mechanism comprising a gear 140 to facilitate controlling (stopping) the extension and retraction of line 200. As shown, gear 140 can include a core portion 142 (i.e., spool) about which line 200 can be wrapped. More specifically, line 200 can be wound about core portion 142 when gear 140 rotates in a first direction, and unwound when gear 140 rotates in a second direction opposite to the first direction. Preferably, gear 140 is urged in the first direction, for example, by a steel coil spring 146 or other mechanism, so that in the absence of force, line 200 retracts into housing 100. As shown in FIG. 2, a spring housing 148 can be provided. A first spring plate 147a and a second spring plate 147b can be provided for maintaining the retracting mechanism in place, first spring plate 147a and second spring plate 147b each having a projection which extend through corresponding apertures of gear 140, spring 146, spring housing 148, and line 200. In accordance with the embodiment illustrated, housing 100 includes an aperture through which line 200 can extend through housing 100.

Housing 100 can also include a button 120, preferably on the surface of housing 100, by which the user can control line 200 and thus the leashed pet. Button 120 can allow the user to either stop or lock line 200 in place or to release line 200 and allow it to retract into housing 100 or to be further pulled out by the pet. For example, if the pet is moving away from the user, thus extending line 200, the user can depress button 120 and stop line 200 from extending any further. Preferably, button 120 includes a gripping element to enhance friction, and is connected to a button base 122, which is preferably secured to housing 100 by securing members 124a and 124b.

A spring 126 can be provided between button 120 and shell 102a, 102b or button base 122. Therefore, button 120 can be urged away from shell 102a, 102b, and thus when button 120 is in the default position in which button 120 is not depressed, line 200 is free to extend and retract, according to which force is greater. More specifically, if the force exerted by the pet is greater than the force of the spring 146 urging gear 140 in the first direction, gear 140 rotates in the second direction and line 200 extends out from housing 100. If the force exerted by the pet is less than the force of spring 146 urging gear 140 in the first direction, gear 140 rotates in the first direction and line 200 retracts into housing 100.

In accordance with the embodiments of the invention shown, housing 100 includes a single button 120, which preferably allows the user to manipulate the leash with one or more fingers of the hand holding housing 120.

Housing 100 can include an opening through which line 200 can extend from inside housing 100 to outside housing 100. A securing member 240 can be provided within the opening, securing member 240 having an aperture 242 through which line 200 can extend. Securing member 240 preferably helps secure, guide, and/or protect line 200 as it extends and retracts through aperture 242. Preferably, aperture 242 is smaller than clasp 210, and more preferably smaller than collar connector 230. Therefore, clasp 210 can be prevented from entering housing 100, and can be readily accessible to the user.

Additionally, a locking mechanism preferably permits the user to lock button 120 in the depressed position. Preferably, when button 120 is in the depressed position, line 200 is prevented from extending or retracting. Referring to the embodiment shown in FIGS. 2 and 5, button base 122 includes a flange 128 and housing 100 includes a groove 104, wherein flange 128 is constructed and arranged to be received within groove 104. FIG. 5 illustrates button 120 in the default position, wherein line 200 is free to extend and retract. As shown, button 120 is urged away from shell 102a, 102b by spring 126. When button 120 is depressed, flange 128 preferably aligns with groove 104. Button 120 can then be urged toward groove 104 until flange 128 is received in groove 104 and button 120 is in the locked position. Once button 120 is released, spring 126 preferably urges button 120 away from shell 102a, 102b. However, flange 128 is preferably prevented from moving away from shell 102a, 102b by the outer wall of groove 104, thereby preventing button 120 from being displaced away from shell halves 102a, 102b.

In the embodiment of the invention shown in FIG. 2, securing members 124a, 124b can include a projection 130 extending toward gear 140 and gear 140 can include a plurality of teeth 144. Preferably, projection 130 can be received within the gaps between teeth 144 to stop line 200 from unwinding from spool 142. Projection 130 is preferably displaced toward gear 140 when button 120 is depressed, and away from gear 140 when button 120 is released. When button 120 is depressed, projection 130 can be displaced toward gear 140 until projection 130 enters the gap between two teeth 144 of gear 140. Projection 130 preferably abuts a tooth 144 to prevent gear 140 from rotating past projection 130. Once button 120 is slid into the locked position, projection 130 is preferably prevented from being displaced out of the gap between teeth 144 of gear 140, and thus the length of line 120 can be maintained. In accordance with the embodiment shown, the gap between two adjacent teeth 144 is greater than the width of projection 130. Therefore, gear 140 may be permitted to rock back and forth, the degree of rotation limited by respective tooth 144 contacting projection 130. Alternatively, a tighter fit can be provided.

Housing 100 preferably has a generally spherical shape, and more preferably a substantially ball-shaped ovaloid, ellipsoid, or multifaceted polyhedron. Housing 100 preferably has a diameter of under about 5 inches, preferably between about 1 to 4 inches, more preferably between about 1.5 to 3 inches and most preferably about 2 to 3 inches, formed to fit comfortably in the palm of an adult user's hand. Preferably, housing 100 has a shape and size that is designed to fit in the palm of the user's hand. Therefore, the weight of line 200, gear 140 and the corresponding components can be provided in a sphere that is preferably easy to hold. This can be more beneficial than retractable leashes currently available in the market that stores the line in a container away from a handle. Accordingly, leash 10 preferably provides added comfort and convenience to the user.

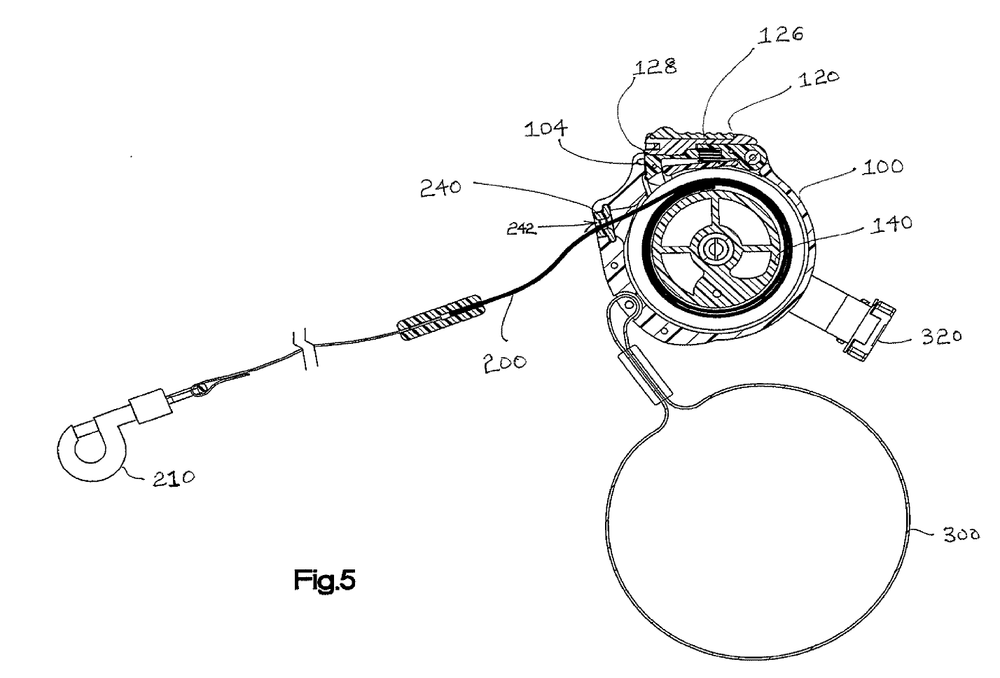

In accordance with another embodiment of the invention, housing 100 includes a hand strap 320 constructed and arranged to secure housing 100 to the user's hand. Hand strap 320 can be made from a variety of materials, by way of non-limiting example, fabric, rope, elastic or non-elastic material, etc., without deviating from the scope of the invention. In accordance with the embodiment of the invention shown in FIG. 1, hand strap 320 can be looped around the hand of the user and is attached to housing 100 at two opposite sides of hand strap 320. For example, as shown in FIG. 4, hand strap 320 can include two ends, each end being connected to one of shells 102a, 102b of housing 100. Hand strap 320 is also preferably provided with a clasp 325, so that hand strap 320 can be cinched tightly to hold housing 100 against the user's hand. Thus, housing 100 preferably fits and is maintained in the palm of the user's hand without requiring the user to grasp housing 100 with their fingers. Such an arrangement preferably provides the user with enhanced control and hold even when the user is not actively grasping housing 100 with their fingers. Thus, leash 10 preferably reduces the occurrence of grip fatigue while maintaining control over the pet, which can provide additional convenience.

As shown, a wrist strap 300 can also be provided to secure leash 10 to the user. Wrist strap 300 may facilitate positioning and/or maintaining housing 100 in position in the user's palm. Preferably, when the user has leash 10 in position, housing 100 rests on the user's palm, and button 120 is proximate the user's finger(s), more preferably proximate the index or middle finger. Such an arrangement preferably facilitates controlling button 120. Furthermore, the size and shape of housing 100 preferably compliments the natural curvature of the user's hand when the hand is relaxed, such that the hand naturally hugs housing 100 without requiring any effort on the user's part.

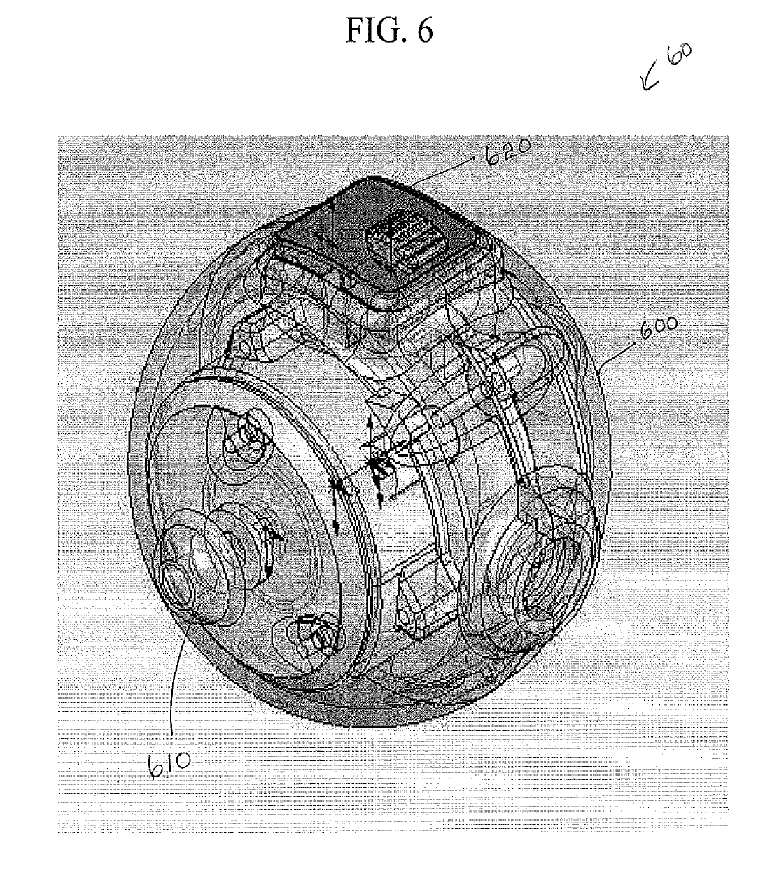

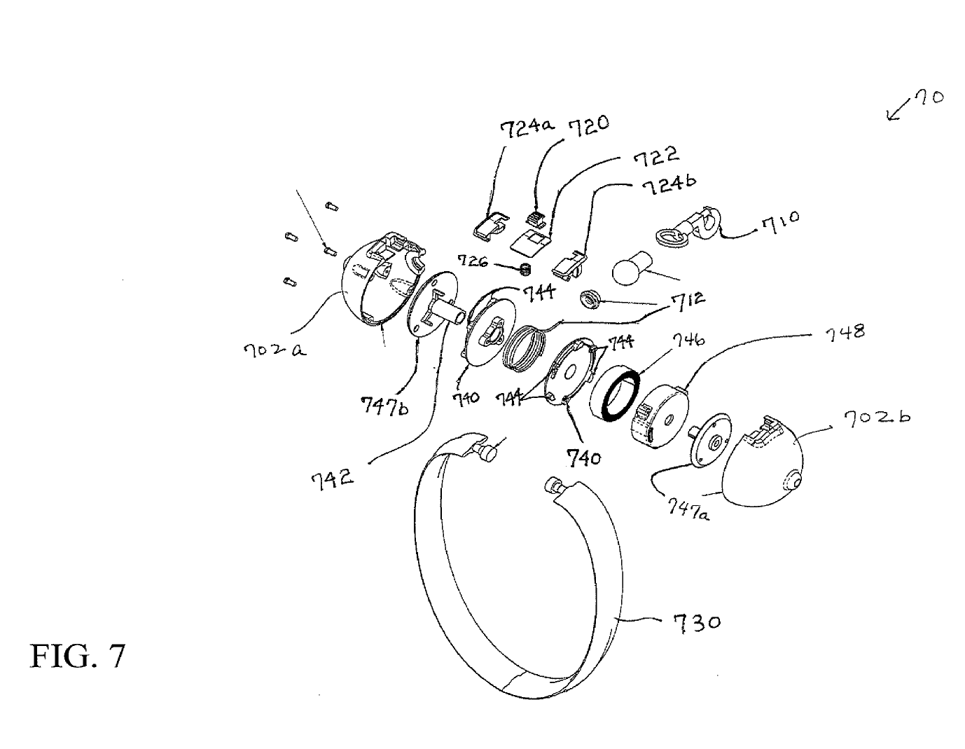

FIGS. 6-7 show alternate embodiments of the leash in accordance with the invention. In FIG. 6, a second retractable leash system 60 is shown having a generally spherical housing 600 having a mount 610 and a button 620. Button 620 is preferably depressible, slidable, or otherwise displaceable to control (stop, lock, release) a line (not shown). Mount 610 is preferably constructed and arranged to receive or otherwise attach to a hand strap (not shown).

Referring to FIG. 7, wherein another embodiment of the invention is shown, a third retractable leash system 70 includes a housing having a pair of shell halves 702a, 702b which can interlock to create a shell. Within the shell can be a retracting mechanism that functions similarly to the retracting mechanism described above with respect to FIGS. 1-5. More specifically, the retracting mechanism of third retractable leash system 70 can include a first spring plate 747a and a second spring plate 747b, preferably constructed and arranged to interlock with each other to keep the retracting mechanism together. In the embodiment shown, second spring plate 747b includes a core 742 about which a line 712 can wrap and unwrap. A steel coil spring 746 can be received in a spring housing 748, which is preferably connected to a gear 740 having a plurality of teeth 744. As shown in FIG. 7, two gears 740 can be provided, wherein one gear 740 is located on each side of line 712. Preferably, gears 740 interlock with each other such that respective teeth 744 are aligned to provide a unified movement as gears 740 rotate about core 742. A button 720 can also be provided, button 720 being urged away from shell halves 702a, 702b by a button spring 726, button 720 also having a button base 722 and a plurality of securing members 724a, 724b.

As shown in FIG. 7, third retractable leash system 70 can also include a hand strap 730 constructed and arranged to secure third retractable leash system 70 against the palm of the user's hand. A clasp 710 can be provided to attach line 712 to the pet's collar or other suitable device.

These embodiments also include a housing within which a retracting mechanism is provided for retracting the line into the housing. A button for stopping or restricting the retracting mechanism and a mechanism for locking the button in the stopped position are also provided. Additionally, the embodiments include a wrist strap and a hand strap to secure the housing in the palm of a user's hand in accordance with the embodiment described above.

The examples provided are merely exemplary, as a matter of application specific to design choice, and should not be construed to limit the scope of the invention in any way. Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. A retractable leash system comprising:
a housing having a generally spherical shape and an overall diameter of about 1.5 to 4 inches;
a retractable line storage reel mounted within the housing;
a length of line having one end connected to the reel and the other end extending from the housing;
the retractable line storage reel constructed and arranged to urge the line back into the housing with a retraction force, but permitting the line to be pulled from the housing when the retraction force is overcome;
a stop mechanism mounted on the housing, the stop mechanism constructed to engage the retractable line storage reel by positive cam interaction to stop the line from unwinding from the retractable line storage reel when the stop mechanism is activated;
a hand strap disposed across the surface of the housing, the hand strap having a clasp for adjusting the length of the strap, wherein the housing, the strap and the clasp are constructed and arranged to secure the housing against a user's palm when the strap is tightened around a hand of a user inserted between the strap and the housing with the user's palm facing the housing; and
a loop sized and positioned on the housing so that a user can slip the loop over the user's hand and around the user's wrist.

2. A retractable leash comprising:
a housing having a spherical shape;
a line constructed and arranged to connect to an animal;
a retracting mechanism constructed and arranged to retract the line;
a button constructed and arranged to selectively engage the retracting mechanism, the button having a released position in which the button does not engage the retracting mechanism, a stopped position in which the button engages the retracting mechanism to limit the retraction and extension of the line, and a locked position in which the button is locked in the stopped position;
a wrist strap attached to the housing, the wrist strap being constructed and arranged to position and secure the housing to the palm of a user; and
a hand strap attached to the housing, the hand strap being constructed and arranged to position and secure the housing to the palm of a user's hand.

3. A retractable leash comprising:
a line;
a housing constructed and arranged to receive the line therein, the housing having a spherical shape;
a hand strap attached to the housing, the hand strap being constructed and arranged to position and secure the housing to the palm of a user's hand.

4. The retractable leash of claim 3, further comprising a spool constructed and arranged within the housing such that the line wraps around the spool.

5. The retractable leash of claim 3, further comprising a rotatable spool connected to the line, wherein the spool is constructed and arranged to rotate in a retracting direction to wrap the line about the outer perimeter of the spool.

6. The retractable leash of claim 3, further comprising a rotatable spool connected to the line, wherein the spool is constructed and arranged to rotate in an extending direction to unwind the line from about the outer perimeter of the spool.

7. The retractable leash of claim 3, further comprising a retracting mechanism within the housing, the retracting mechanism constructed and arranged to retract the line into the housing.

8. The retractable leash of claim 3, wherein the hand strap is constructed and arranged to position and secure the housing to the palm of a user's hand such that the button is proximate a finger of said hand.

9. The retractable leash of claim 3, wherein the housing has a diameter of less than 5 inches.

10. The retractable leash of claim 3, wherein the housing has a diameter of between 1 and 4 inches.

11. The retractable leash of claim 3, wherein the housing has a diameter of between 1.5 and 3 inches.

12. The retractable leash of claim 3, further comprising a button having a released position in which the line is free to move, a stopped position in which the line is prevented from retracting or extending beyond a certain point, and a locked position in which the button is locked in the stopped position.

13. The retractable leash of claim 12, further comprising a spring constructed and arranged to urge the button toward the released position.

14. The retractable leash of claim 12, further comprising a locking mechanism for maintaining the button in the locked position.

15. The retractable leash of claim 12, further comprising a gear constructed and arranged to engage the button when the button is in the stopped position.
